(19) United States
(12) Patent Application Publication
(10) Pub. No.: US 2016/0292953 A1
(43) Pub. Date: Oct. 6, 2016

(54) PACKAGED ICE VENDING MACHINE

(71) Applicant: Donald Ray Brown, Roswell, GA (US)

(72) Inventor: Donald Ray Brown, Roswell, GA (US)

(21) Appl. No.: 15/092,104

(22) Filed: Apr. 6, 2016

Related U.S. Application Data
(60) Provisional application No. 62/143,292, filed on Apr. 6, 2015.

(51) Int. Cl. G07F 17/00; F25C 5/00; G07F 11/10; G07F 11/22; G07F 9/10; G07F 11/42

(52) U.S. Cl. CPC G07F 17/0071; G07F 9/105; G07F 11/42; G07F 11/10; G07F 11/22; F25C 5/002

(57) ABSTRACT

Embodiments of packaged ice vending machines are provided. One embodiment comprises an array having a plurality of longitudinal dispensing cells. Each of the dispensing cells has a substantially horizontal surface that supports a respective ice package and a dispensing cell opening sized to permit passage of the respective ice package through the dispensing cell opening when pushed in a direction toward the dispensing cell opening. An elongated vertical ice package chute receives ice packages from the plurality of dispensing cell openings and delivers the ice packages to an ice package dispensing surface situated below the dispensing cell openings. The ice package dispensing surface is accessible by a user of the vending machine to enable the user who is situated outside of the vending machine to remove a vended ice package. A belt extends continuously in a substantially horizontal serpentine manner through the plurality of dispensing cells so that a part of the belt can cause a rear part of each of the ice packages to be pushed, directly or indirectly. The belt is fixedly secured at one end and secured to a spool on the other end. The spool pulls and coils the belt when the spool is rotated to thereby cause the vended ice package to be pushed on the rear part toward and through the respective dispensing cell opening and then into the vertical chute. An electric motor exerts rotational force on the spool in order to roll up and pull on the belt during a vending operation associated with the vended ice package.

### CLAIM OF PRIORITY

This application claims the benefit of and priority to U.S. provisional application No. 62/143,292, filed Apr. 6, 2015, which is incorporated herein by reference in its entirety.

### FIELD OF INVENTION

The application generally relates to vending machines, and more particularly, to vending machines that enable the storage, purchase, and dispensing of packages of ice.

### BACKGROUND OF THE INVENTION

Current designs of packaged ice vending machines often incorporate a conveyor belt system to dispense ice packages, typically in the form of sealed plastic bags of ice. U.S. patent application publication no. 2013/0341344, which is incorporated herein by reference, shows and describes an example of the foregoing design. While a simple and reliable design to dispense ice, it is expensive and lacks the ability to store a sufficient number of bags to make this design economically viable. Better designs for such vending machines are needed.

### SUMMARY OF THE INVENTION

Embodiments of packaged ice vending machines are provided. Some of these embodiments are summarized hereafter.

One embodiment of a packaged ice vending machine, among others, comprises a array having a plurality of longitudinal dispensing cells. Each of the dispensing cells has a substantially horizontal surface that supports a respective ice package and a dispensing cell opening sized to permit passage of the respective ice package through the dispensing cell opening when pushed in a direction toward the dispensing cell opening. An elongated vertical ice package chute receives ice packages from the plurality of dispensing cell openings and delivers the ice packages to an ice package dispensing surface situated below the dispensing cell openings. The ice package dispensing surface is accessible by a user of the vending machine to enable the user who is situated outside of the vending machine to remove a vended ice package. A belt extends continuously in a substantially horizontal serpentine manner through the plurality of dispensing cells so that a part of the belt can cause a rear part of each of the ice packages to be pushed, directly or indirectly. The belt is fixedly secured at one end and secured to a spool on the other end. The spool pulls and coils the belt when the spool is rotated to thereby cause the vended ice package to be pushed on the rear part toward and through the respective dispensing cell opening and then into the vertical chute. An electric motor exerts rotational force on the spool in order to roll up and pull on the belt during a vending operation associated with the vended ice package.

Another embodiment of a packaged ice vending machine comprises a storage means for containing a plurality of the ice packages and a belt means. The belt means pushes the ice packages forward, one by one, from the storage means to a dispensing area where an ice package can be retrieved by a user during a vending operation. In this embodiment, the belt means comprises a singular flexible belt extending in a serpentine manner through the plurality of ice packages. The belt is fixed at one end and movable at the other end so that when the belt is moved at the movable end, the belt pushes the ice package to the dispensing area.

Another embodiment of a packaged ice vending machine comprises a plurality of longitudinal dispensing cells. Each of the dispensing cells has a substantially horizontal surface that supports the ice packages and a dispensing cell opening sized to permit passage of the respective ice packages through the dispensing cell opening when moved in a direction toward the dispensing cell opening. An elongated vertical ice package chute is sized to receive the ice packages from the plurality of dispensing cell openings and deliver the ice packages to an ice package dispensing surface situated below the dispensing cell openings. The ice package dispensing surface is accessible by a customer of the vending machine to enable the customer who is situated outside of the vending machine to remove the ice packages, when appropriate, during a vending operation. This embodiment further includes a means for receiving money during the vending operation as payment for one or more ice packages and for advising a controller and a means for moving the one or more ice packages through their respective dispensing cell opening and then into the vertical chute, when appropriate, under the control of the controller, based upon the money received by the money receiving means.

Another embodiment of a packaged ice vending machine comprises a plurality of longitudinal dispensing cells, an elongated vertical ice package chute, a first lockable door, and a second lockable door. The dispensing cells are arranged and aligned substantially horizontally. Each of the dispensing cells has a substantially horizontal surface that supports a respective ice package and a dispensing cell opening sized to permit passage of the respective ice package through the dispensing cell opening when pushed in a direction toward the dispensing cell opening. The elongated vertical ice package chute is sized to receive ice packages from the plurality of dispensing cell openings and deliver the ice packages to an ice package dispensing surface situated below the dispensing cell openings. The ice package dispensing surface is accessible by a customer of the vending machine to enable the customer who is situated outside of the vending machine to remove a vended ice package. The first lockable door can be opened and closed to provide access to an electronic control system that controls the vending operation and a money storage means so that the electronic control system can be serviced and the money storage means without exposing the ice packages to the environment outside of the vending machine. The second lockable door can be opened and closed to provide access to the plurality of dispensing cells so that the dispensing cells can be loaded with the ice packages without providing access to the electronic control system and the money storage means.

Another embodiment of a packaged ice vending machine stores different types of ice packages to be dispensed. The input control(s) on the machine enable a user to select one of the different types of ice packages to be dispensed. The vending machine dispenses the type that has been selected by the user.

Other embodiments, methods, apparatus, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of the packaged ice vending machine in accordance with the preferred embodiment of the present invention.

FIG. 2 is a perspective view of the packaged ice vending machine of FIG. 1 with a package dispensing compartment opened to show how an ice package is dispensed after a purchase of same by a customer.

FIG. 3A is a front view of the packaged ice vending machine of FIG. 1.

FIG. 3B is a cross sectional view of the packaged ice vending machine of FIG. 1, taken along line A-A shown in FIG. 3A.

FIG. 4 is a perspective view of the packaged ice vending machine of FIG. 1 with front doors and package dispensing compartment removed to show internal parts of the machine.

FIG. 5A is a front view of the right door of the packaged ice vending machine of FIG. 1 showing a money/controller panel attached thereto.

FIG. 5B is a rear view of the right door of FIG. 5A.

FIG. 6 is a perspective view of the dispensing array of the packaged ice vending machine of FIG. 1, which is installed within an outer cabinet associated with the packaged ice vending machine.

FIG. 7A is a top cutaway view of a horizontal shelf (or row) of longitudinal dispensing cells (each cell containing a plurality of contiguous aligned ice packages) in the dispensing array of the packaged ice vending machine of FIG. 1, showing how a pusher plate in one of the dispensing cells is moved from back to front with a belt that is pulled and rolled up onto a spool driven by a gearmotor when ice packages are dispensed.

FIG. 7B is a top cutaway view of the horizontal shelf (or row) of dispensing cells of FIG. 7B, showing how all of the pusher plates can be moved from back to front with the belt to dispense all of the ice packages in the horizontal shelf.

FIG. 8A is a front cutaway view of the dispensing array having a plurality of horizontal shelfs of dispensing cells of the packaged ice vending machine of FIG. 1.

FIG. 8B is an enlarged view of a dispensing cell with an ice package, showing a shelf empty sensor located at the bottom and end of the dispensing cell that senses when all ice packages of the dispensing cell have been dispensed.

FIG. 9 is an enlarged view of the motor and spool assembly of the packaged ice vending machine of FIG. 1, showing how the spool is driven and showing how a friction screw is used to ensure that the spool does not freely rotate when not driven by the motor.

FIG. 10 is a wire diagram showing electrical wiring and connections associated with the packaged ice vending machine of FIG. 1.

### DETAILED DESCRIPTION OF THE PREFERRED EMBODIMENT

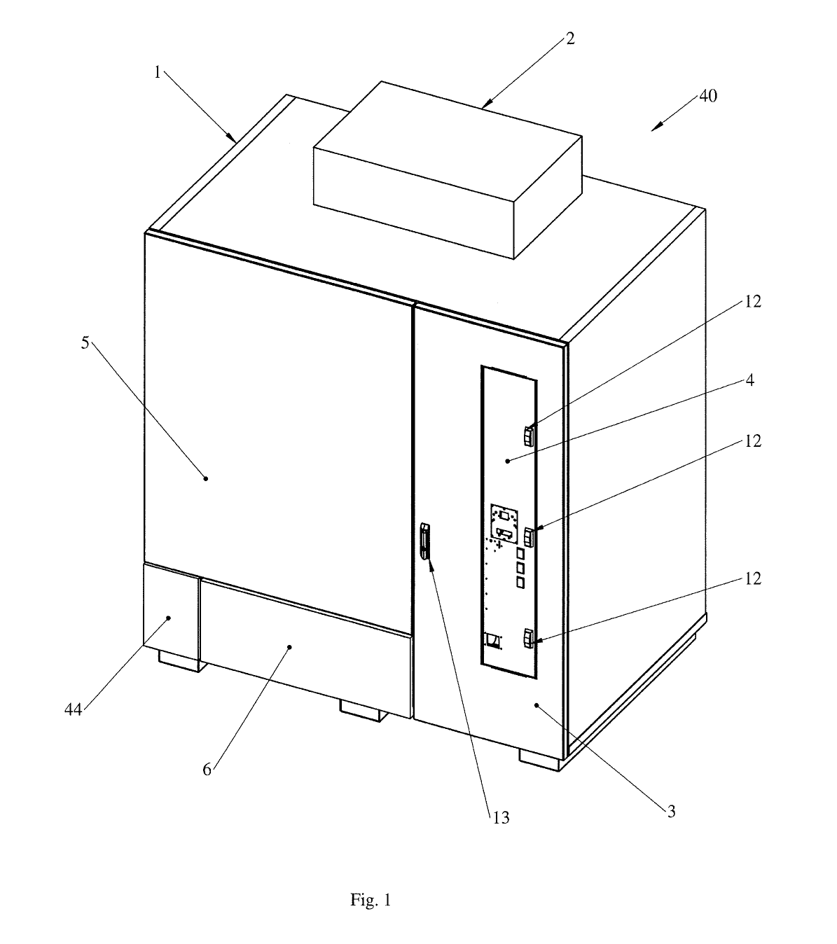

In FIG. 1, there is shown, in perspective, a preferred embodiment of a packaged ice vending machine 40 in accordance with the present invention. The packaged ice vending machine 40 is designed to enable the refrigerated storage, purchase, and dispensing of packages 20 (e.g., 10 lb. bags) of ice, which are preferably pre-sealed by any suitable mechanism or method, including tied, hermetically sealed, etc. A delivery or service person periodically loads the vending machine 40 with the ice packages 20, as needed, which are then dispensed as customers purchase the ice packages 20. The design of the packaged ice vending machine 40 enables, among other things, the very efficient storage and dispensing of numerous ice packages 20. Also, the dispensing apparatus associated with the vending machine 40, which will be described in detail hereafter, avoids use of costly conveyor belt systems, thus making the vending machine 40 much more economically viable compared to prior art packaged ice vending machines.

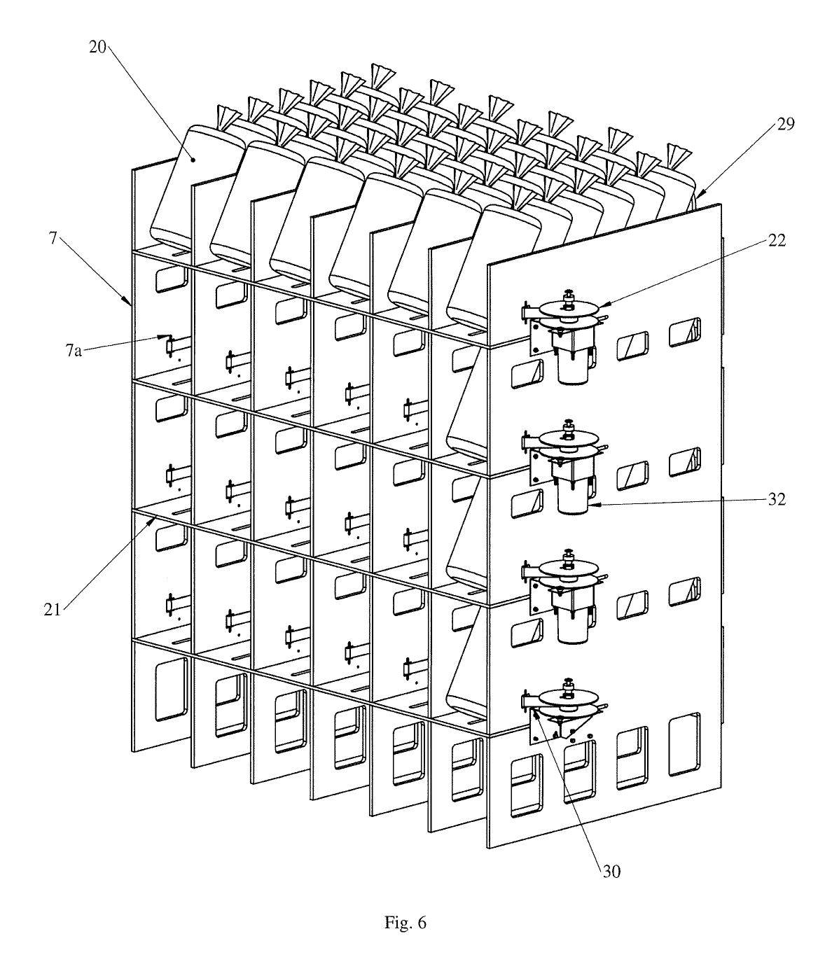

As illustrated in FIG. 1, the packaged ice vending machine 40 of the present disclosure comprises an insulated cabinet 1 having a left door 5 that opens and closes around a hinge at its left side, a right door 3 that opens and closes around a hinge at its right side, a package dispensing compartment 6 having a tiltable generally U-shaped structure, a cooling compressor system 2 for refrigeration, a money/control access door 4 with three vertically spaced door locks 12, and a cabinet lock 13 that essentially locks and unlocks both doors 3, 5. Referring to FIG. 6, an orthogonal dispensing array 7 is situated in the cabinet 1. The dispensing array 7 utilizes a conventional motor 32 (e.g., a gearmotor), a generally cylindrical spool 22 driven by the motor 32, a flexible belt 30 rolled by the spool 22, and a plurality of pusher plates 29 that are pushed by the belt 30 to effectively dispense ice packages 20 into the package dispensing compartment 6, without the use of a much more expensive conveyer belt system. Further note that the doors 3, 5 as well as other panels and parts of the vending machine 40 can be manufactured from any suitable rigid materials, including metal, plastic, etc.

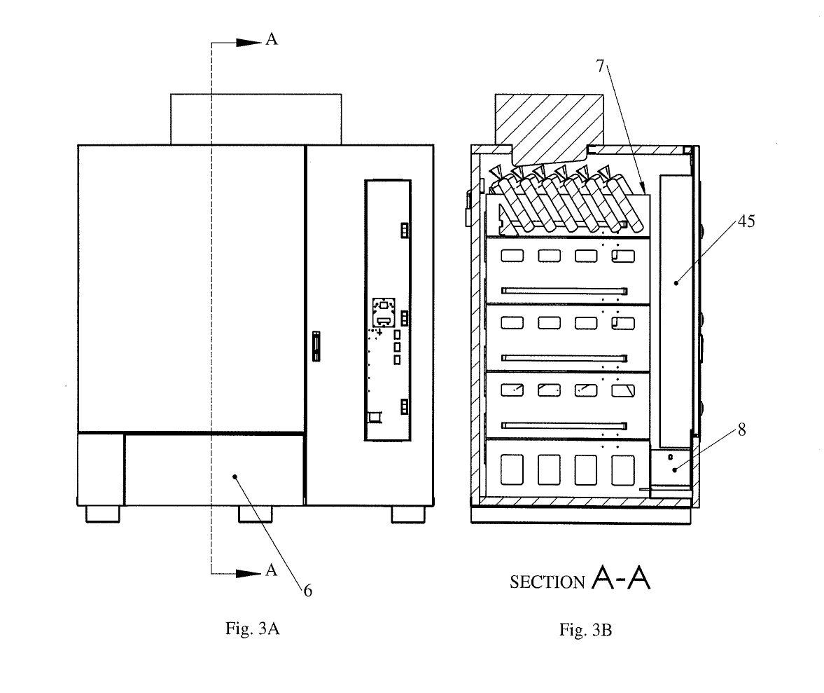

When the cabinet lock 13 is opened, the right door 3 can be opened, which allows the left door 5 to be opened, because the left side of the right door 3 slightly overlaps the right side of the left door 5. The right and left doors 3, 5 can be opened and closed to expose a plurality of longitudinal dispensing cells 7a that receive and house the ice packages 20, so that the longitudinal dispensing cells 7a can be loaded with the ice packages 20, without providing access to the electronic control system that controls vending operations and to money associated with the vending operations. The door 4 can be opened and closed to provide access to the electronic control system (in insulated box 45 of FIG. 3B) that controls the vending operation and to money associated with the vending operation, so that the electronic control system can be serviced and money accessed without exposing the ice packages 20 to a higher temperature environment outside of the cabinet 1 in order to keep the ice packets 20 refrigerated. Note that this design enables the person that services the electronic control system and/or money to be different than the person that loads the ice packages 20.

The preferred process for constructing the vending machine 40 is as follows. The dispensing array 7 is constructed first by assembling a multiple box plastic array using vertical uprights and horizontal shelves as shown in FIG. 6. The array 7 can be designed to include any number of rows and columns of longitudinal dispensing cells 7a. In the example associated with the preferred embodiment, as is illustrated in FIG. 6, the array 7 includes 4 rows and 6 columns of longitudinal dispensing cells 7a, or a total of 24 longitudinal dispensing cells 7a, each of which can store and dispense 6 ice packages 20. Thus, this array 7 can store and dispense a total of 144 ice packages 20 (e.g., 10 lb. ice bags).

To this array 7 are attached the motor 32, which has a spool 22 attached to the shaft 33 of the motor 32, as shown in FIG. 13. There is then attached a friction screw 35 to keep the spool 22 from freely spinning when not rotated by the motor 32 by exerting force against an inner side wall of the spool 22. Other embodiments for preventing the spool 22 from freely rotating are possible, including for example, positioning and exerting a spring-loaded arm against the spool 22 or motor shaft. Next, on top of the motor shaft 33 is attached an engaging knob 34 that affixes the spool 22 to the shaft 33 so that the spool can be driven and rotated by the motor 32.

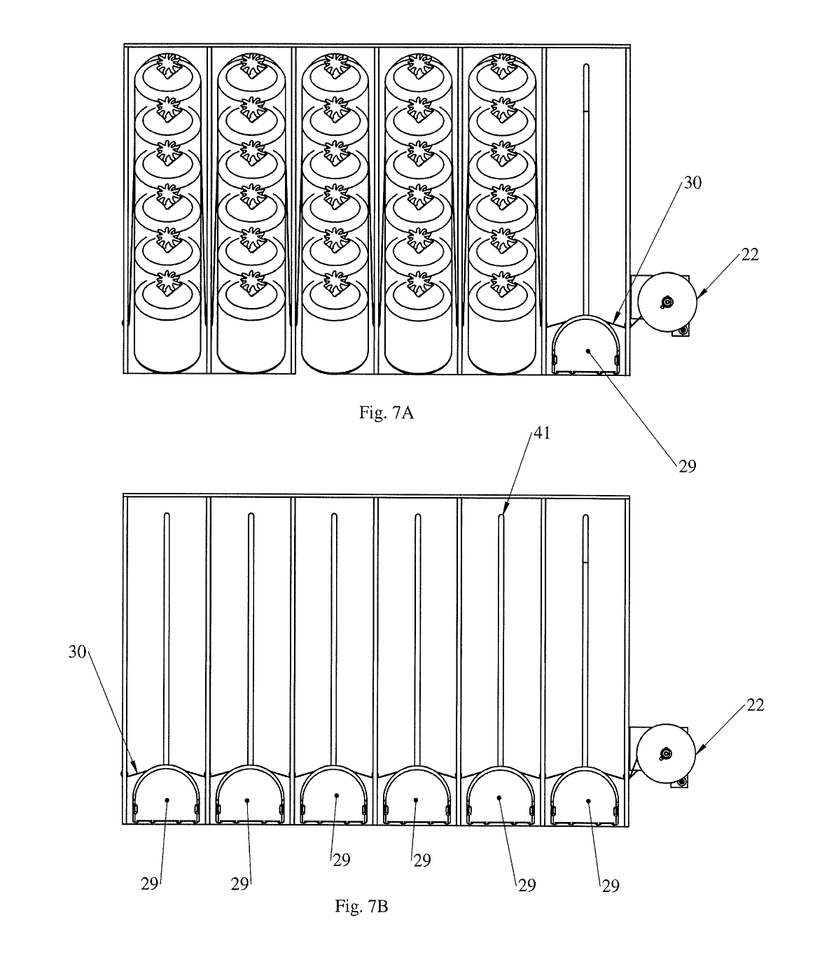

Referring now to FIGS. 7A and 7B, each horizontal shelf within the dispensing array 7 has one motor assembly, spool 22, and flexible belt 30. The flexible belt 30, preferably a singular rubber belt of a sufficient width, is weaved behind the pusher plates 29 associated with the horizontal shelf through an opening in the plastic upright until all pusher plates 29 have been captured, or engaged, by the belt 30. The pusher plates 29 are designed to maintain the belt 30 at an elevated vertical position on the rear part of each of the pusher plates 29. The belt 30 is fixedly attached to the far left wall of the cabinet 1 and is movable at the right wall of the cabinet 1 via the spool 22. Each pusher plate 29 slides from back to front using an elongated linear channel, or slot, 41 in the shelf as a guide. Each pusher plate 29 comprises a channel guide that extends outwardly into the linear channel 41, which could be associated with any suitable wall of the longitudinal dispensing cell 7a, but is preferably associated with the bottom, in order to guide the pusher plate 29 in a linear manner as the pusher plate 29 is moved by the belt 30. Thus, the flexible belt 30 extends in a generally serpentine manner through the plurality of ice packages 20, and the belt 30 is fixed at one end and movable at the other end so that when the belt 30 is moved at the movable end, the belt pushes the ice package 30 off of the horizontal shelf, and the ice package 30 falls by force of gravity to the dispense compartment 6.

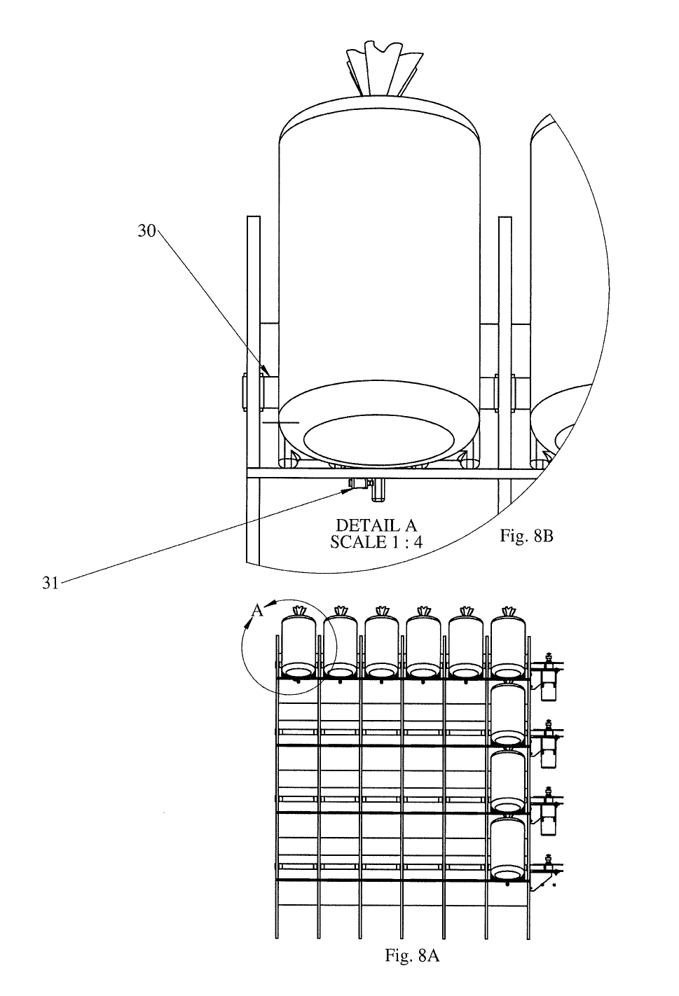

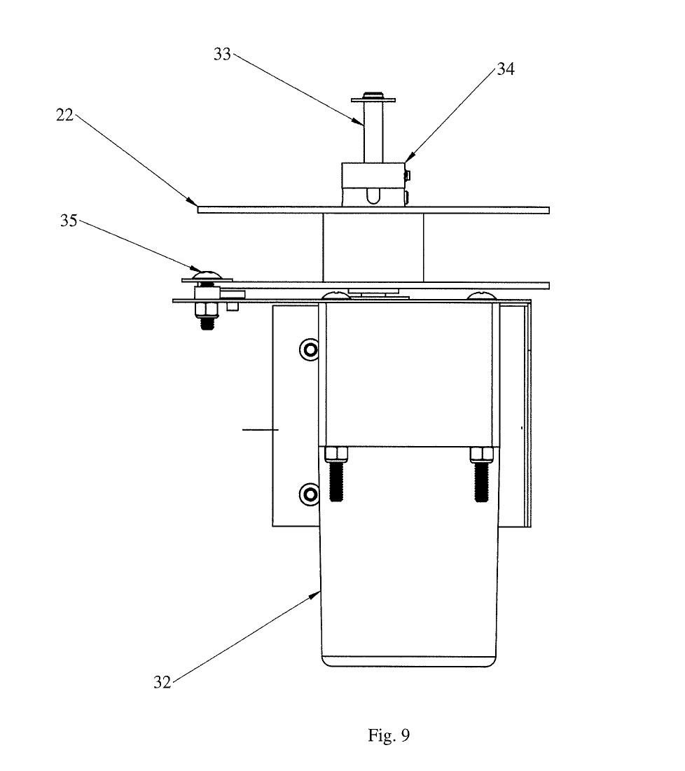

With reference to FIGS. 8A and 8B, there is also attached to the underside of the far left column of dispensing cells 7a a shelf empty sensor 31 (e.g., a light sensor, proximity sensor, etc.), which is designed to communicate an appropriate signal to the controller 46 indicating when the corresponding horizontal shelf is empty of ice packets 20.

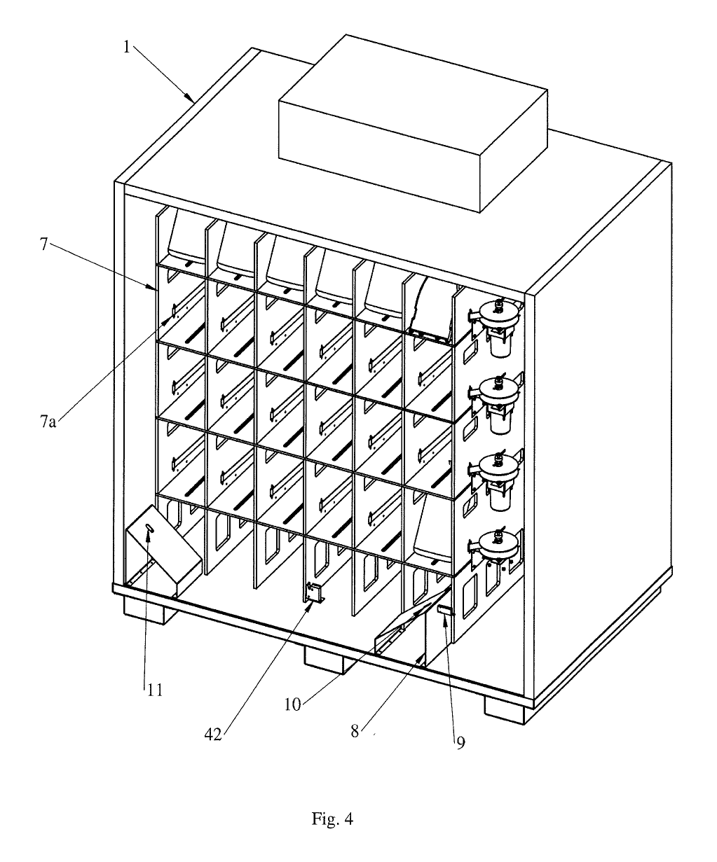

Once the dispensing array 7 and related parts are completely assembled, it is then placed into the insulated cabinet 1, as shown in FIG. 4. On the floor of the cabinet 1 is attached the generally U-shaped product dispensing compartment lock 42 and an angled left slide 11 and an angled right slide 10. Each slide 10, 11 has a hole, which a package detect sensor 9 (e.g., a light sensor, proximity sensor, etc.) is attached and is used to detect the presence of an ice package 20. As can be appreciated by FIG. 4, when installed, the right and left doors 3, 5, the package dispensing compartment 6, the angled slides 10, 11, and the internal array 7, together, create an elongated vertically-oriented ice package chute that is sized to receive ice packages 20 from the plurality of dispensing cell openings and deliver the ice packages 20 to a dispensing surface situated below the dispensing cell openings and associated with the product dispensing compartment 6.

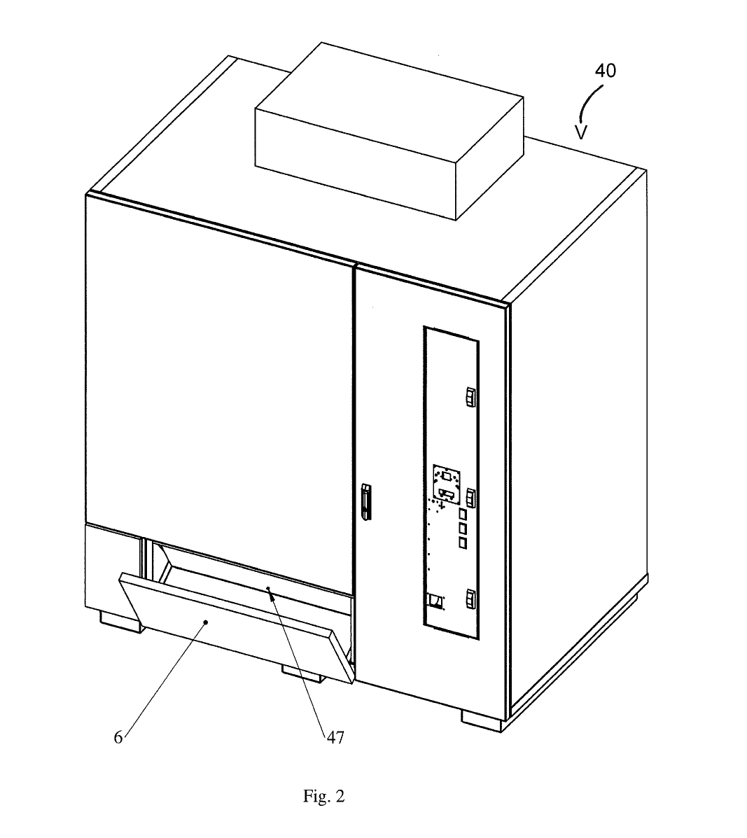

As shown in FIG. 1, upon completing the internal parts and installing them in the cabinet 1, the bottom panel 44 is attached to the cabinet 1 along with the package dispensing compartment 6, which has a locking pin 47 (FIG. 2), the left door 5, and the right door 3. The right door 3 then has a money/controller panel 4 attached, as shown in FIG. 6. The money/controller panel 4 has a locking mechanism, preferably three vertically spaced door locks 12, a plurality of quantity selection buttons 16, 17, 18, a coin insert slot 15 that receives coins, a bill validator 14 that receives paper money, a coin return cup 19 that receives dispensed change, and the vend controller 46 (computer based architecture) that controls all operations. Also attached to the right door 3 is an insulated box 45, as shown in FIG. 3B. The cooling compressor 2 is then assembled on top of the cabinet, as shown in FIG. 1. The cooling compressor 2 is well known and commercially available and is designed to blow cold air into the cabinet 1 and maintain a refrigerated temperature therein in order to refrigerate the ice packets 20.

FIG. 10 is a wire diagram showing electrical wiring and connections associated with the packaged ice vending machine of FIG. 1. All of the parts in FIG. 10 are well known in the art and are commercially available from a number of vendors.

### Operation

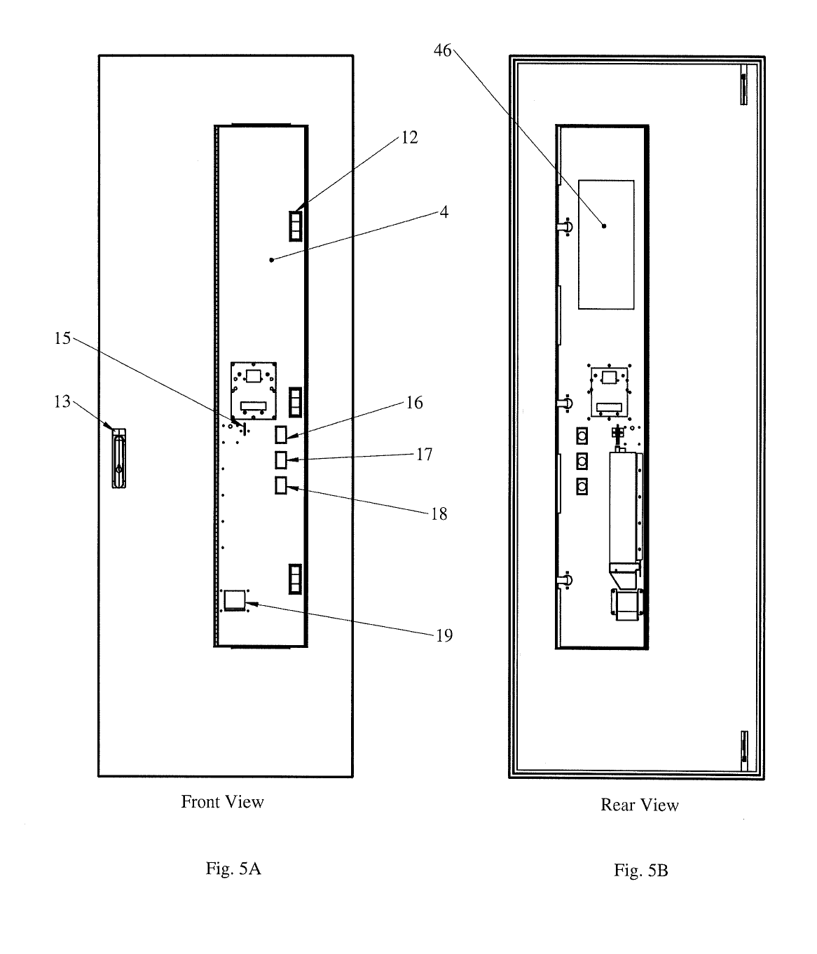

The vending machine 40 operates as follows. A customer deposits money using the coin insert 8 and/or bill validator 9, as shown in FIG. 5A. After money is deposited, the customer selects, by pushing, one of quantity selection buttons 16, 17 or 18, which correspond to different quantities of ice packages 20 that are desired. Upon pushing the selection button 16, 17, or 18, the vending controller 46 activates the appropriate motor 32, as shown in FIGS. 7A and 7B, which turns the spool 22. Turning the spool starts to pull and roll up the belt 30, which will tighten the belt 30, causing a pusher plate 29 to move forward. This pusher plate 29 will cause an ice package 20 to move forward and eventually fall off a horizontal dispensing shelf. When the ice package 20 falls, the ice package 20 will activate the product detect sensor 9, as shown in FIG. 4, and the vend controller 46 will turn off motor 32. The vend controller 46 then activates package dispensing compartment lock 42, which releases locking pin 47, allowing the customer to open package dispensing compartment 6 and remove the ice package 20 contained therein.

Should the customer select multiple bag selection buttons 17 or 18, then the foregoing process will repeat until all of the ice packages 20 have been dispensed. Once all the ice packages 20 are dispensed from a given row, the shelf empty sensor 31 will signal vend controller 46 to disable that row's motor 32 and, if necessary, start dispensing from the next row of cells 7a using that row's motor 32, as shown in FIGS. 7A and 7B. This process will continue until all shelf empty sensors 31 have been activated, and the vend controller 46 will then disable the vending machine 40 from accepting any money.

### Alternative Embodiment

In alternative embodiment, the package ice vending machine 40 can be designed to dispense ice packages 20 having a plurality of different types of ice in them. For example, the vending machine 40 can be loaded with spring water ice packages 20a and tap water ice packages 20b. In this embodiment, the packages 20a and packages 20b are loaded and stored on different predefined horizontal shelves of the array 7. One or more of the selection buttons 16-18 can be assigned to each of the different types of ice packages 20. The controller 46, which has pre-existing knowledge of where the ice packages 20a, 20b are located, dispenses the packages 20a, 20b, as selected by the customer via buttons 16-18.

### Variations and Modifications

It should be emphasized that the above-described embodiments of the present invention, particularly, any “preferred” embodiments, are merely possible non-limiting examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

At least the following is claimed:

1. A vending machine for dispensing packages of ice contained therein, the vending machine comprising:
a plurality of longitudinal dispensing cells, each of the dispensing cells having a substantially horizontal surface that supports a respective ice package and a dispensing cell opening sized to permit passage of the respective ice package through the dispensing cell opening when pushed in a direction toward the dispensing cell opening;
an elongated vertical ice package chute sized to receive ice packages from the plurality of dispensing cell openings and deliver the ice packages to an ice package dispensing surface situated below the dispensing cell openings, the ice package dispensing surface being accessible by a user of the vending machine to enable the user who is situated outside of the vending machine to remove a vended ice package;
a generally cylindrical spool;
a belt extending continuously in a substantially horizontal serpentine manner through the plurality of dispensing cells so that a part of the belt can cause a rear part of each of the ice packages to be pushed, directly or indirectly, the belt fixedly secured at one end and secured to the spool on the other end, the spool designed to pull and coil the belt when the spool is rotated to thereby cause the vended ice package to be pushed on the rear part toward and through the respective dispensing cell opening and then into the vertical chute; and
an electric motor designed to exert rotational force on the spool in order to roll up and pull on the belt during a vending operation associated with the vended ice package.

2. The vending machine of claim 1, further comprising a pusher plate in each of the longitudinal dispensing cells, the pusher plates being connected to the belt so that one of the pusher plates pushes the vended ice package during the vending operation.

3. The vending machine of claim 2, wherein the pusher plates are designed to maintain the belt at an elevated vertical position on the rear part of each of the ice packages.

4. The vending machine of claim 2, wherein the pusher plate comprises a channel guide that extends into a linear channel associated with a wall of the longitudinal dispensing cell that guides the pusher plate in a linear manner as the pusher plate is moved by the belt.

5. The vending machine of claim 1, further comprising a door that can be opened and closed to expose the plurality of dispensing cells so that the dispensing cells can be loaded with the ice packages, respectively.

6. The vending machine of claim 1, further comprising a means for receiving money during the vending operation as payment for the ice package.

7. The vending machine of claim 1, further comprising:
a first lockable door that can be opened and closed to provide access to an electronic control system that controls the vending operation so that the electronic control system can be serviced without exposing the ice packages to the environment outside of the vending machine; and
a second lockable door that can be opened and closed to provide access to the plurality of dispensing cells so that the dispensing cells can be loaded with the ice packages without providing access to the electronic control system.

8. The vending machine of claim 7, wherein the first lockable door also provides access to a money storage means associated with vending operation and wherein the second lockable door provides access to the dispensing cells without enabling access to the money storage means.

9. The vending machine of claim 1, further comprising a means for preventing the spool from freely rotating when not rotated by the motor.

10. A vending machine for dispensing packages of ice contained therein, the vending machine comprising:
storage means for containing a plurality of the ice packages; and
belt means for pushing the ice packages forward, one by one, from the storage means to a dispensing area where an ice package can be retrieved by a user during a vending operation, the belt means comprising a singular flexible belt extending in a serpentine manner through the plurality of ice packages, the belt being fixed at one end and movable at the other end so that when the belt is moved at the movable end, the belt pushes the ice package to the dispensing area.

11. The vending machine of claim 10, further comprising a pusher means for receiving pushing force from the belt and exerting pushing force on the ice packages.

12. The vending machine of claim 10, further comprising a belt guiding means for maintaining the belt at a vertical position that is vertically elevated from a bottom associated with each of the ice packages.

13. The vending machine of claim 10, further comprising a door that can be opened and closed to expose a means for storing ice packages.

14. The vending machine of claim 13, wherein the door can be locked and unlocked.

15. The vending machine of claim 10, further comprising means for receiving money during the vending operation as payment for the ice package.

16. The vending machine of claim 10, further comprising:
a first lockable door that can be opened and closed to provide access to an electronic control system that controls the vending operation and a money storage means so that the electronic control system can be serviced and the money storage means without exposing the ice packages to the environment outside of the vending machine; and
a second lockable door that can be opened and closed to provide access to the plurality of dispensing cells so that the dispensing cells can be loaded with the ice packages without providing access to the electronic control system and the money storage means.

17. The vending machine of claim 16, further comprising:
means for receiving money during the vending operation as payment for the ice package, the money receiving means including a money collection area that is exposed when the second lockable door is opened and secured when the second lockable door is closed.

18. A vending machine for dispensing packages of ice contained therein, the vending machine comprising:
a dispensing array having a plurality of longitudinal dispensing cells, each of the dispensing cells having a substantially horizontal surface that supports the ice packages and a dispensing cell opening sized to permit passage of the respective ice packages through the dispensing cell opening when moved in a direction toward the dispensing cell opening;
an elongated vertical ice package chute sized to receive the ice packages from the plurality of dispensing cell openings and deliver the ice packages to an ice package dispensing surface situated below the dispensing cell openings, the ice package dispensing surface being accessible by a customer of the vending machine to enable the customer who is situated outside of the vending machine to remove the ice packages, when appropriate, during a vending operation;
a controller;
means for receiving money during the vending operation as payment for one or more ice packages and for advising the controller; and
means for moving the one or more ice packages through their respective dispensing cell opening and then into the vertical chute, when appropriate, under the control of the controller, based upon the money received by the money receiving means.

19. The vending machine of claim 18, further comprising a plurality of input controls that correspond to different types of ice packages to be dispensed, the controls enabling a user to select the different types and wherein:
the dispensing array comprises at least two horizontal shelves; and
the controller is configured to identify a shelf associated with the shelves based upon the selected type and cause the moving means to move an ice package corresponding to the selected type off of the identified shelf and into the vertical chute.

20. A vending machine for dispensing packages of ice contained therein, the vending machine comprising:
a plurality of longitudinal dispensing cells, each of the dispensing cells having a substantially horizontal surface that supports a respective ice package and a dispensing cell opening sized to permit passage of the respective ice package through the dispensing cell opening when pushed in a direction toward the dispensing cell opening;
an elongated vertical ice package chute sized to receive ice packages from the plurality of dispensing cell openings and deliver the ice packages to an ice package dispensing surface situated below the dispensing cell openings, the ice package dispensing surface being accessible by a customer of the vending machine to enable the customer who is situated outside of the vending machine to remove a vended ice package;
a first lockable door that can be opened and closed to provide access to an electronic control system that controls the vending operation and a money storage means so that the electronic control system can be serviced and the money storage means without exposing the ice packages to the environment outside of the vending machine; and
a second lockable door that can be opened and closed to provide access to the plurality of dispensing cells so that the dispensing cells can be loaded with the ice packages without providing access to the electronic control system and the money storage means.
